(19) United States
(12) Patent Application Publication
(10) Pub. No.: US 2020/0314575 A1
(43) Pub. Date: Oct. 1, 2020

(54) DIAPHRAGM, METHOD FOR MANUFACTURING SAME, AND SPEAKER USING SAME

(71) Applicant: AAC Technologies Pte. Ltd., Singapore City (SG)

(72) Inventors: Ping Liang, Shenzhen (CN); Bin Zhao, Shenzhen (CN); Ye Shang, Shenzhen (CN)

(21) Appl. No.: 16/729,498

(22) Filed: Dec. 30, 2019

(30) Foreign Application Priority Data
Mar. 26, 2019 (CN) 201910233996.3

(51) Int. Cl. H04R 31/00; B32B 37/12; H04R 9/02; H04R 7/04; H04R 7/18; H04R 7/26; H04R 9/06

(52) U.S. Cl. CPC H04R 31/003; B32B 37/12; H04R 9/025; H04R 7/04; H04R 2307/025; H04R 7/26; H04R 9/06; B32B 2457/00; H04R 2400/11; H04R 7/18

(57) ABSTRACT

The invention discloses a diaphragm including a polymer material layer made of polymer material and a porous damping material layer made of porous damping material. The polymer material layer is stacked and fixed onto the porous damping material layer. The beneficial effects of the present invention are: (1) the porous damping material has high structural strength, and can restrain the contractility of polymer material; therefore, it can be ensured that the dimensions of products made of the diaphragm substrate material of the present invention remain consistent. (2) The diaphragm substrate material of the present invention can restrain and improve the variation of the properties of polymer materials under high temperature conditions.

### FIELD OF THE PRESENT DISCLOSURE

The present invention relates to the field of electroacoustic devices, particularly to a diaphragm, and to a method for manufacturing the diaphragm. The present invention further relates to a speaker using the diaphragm.

### DESCRIPTION OF RELATED ART

At present, materials of diaphragm are generally single-layer or composite materials such as silicone rubber, thermoplastic elastomer (TPE), thermoplastic polyurethane elastomer rubber (TPU), etc. These polymer materials have good elasticity with a small modulus, and are often used in the preparation of existing diaphragms. However, because these polymer materials are not resistant to high temperatures. When the temperature rises to a certain level (the product continues to vibrate or perform reliability experiments), in some products, the product amplitude becomes larger and larger, which causes deviations, results in product swing, then directly leads to product performance failure. FIG. 1 is the amplitude change diagram of respective vibration of 20 ms (millisecond) and 500 ms with material of diaphragm at different temperatures, 20 ms and 500 ms represent different time used to test the existing material of diaphragm in the same frequency phase interval, the longer the time, the more vibrations and the higher the product temperature. From the figure we can see the significant deviation of the vibration amplitude of same pint on the product using the existing diaphragm under the test conditions of 20 ms and 50 ms.

Accordingly, an improved diaphragm, and a speaker using the diaphragm are desired to solve the problems mentioned above.

### SUMMARY OF THE PRESENT INVENTION

One of the major objects of the present invention is to provide a diaphragm used in a speaker which can reduce the amplitude deviation under high temperature.

Another of the major objects of the present invention is to provide a method for manufacturing the diaphragm to reduce the amplitude deviation under high temperature.

A further one of the major objects of the present invention is to provide a speaker having the diaphragm.

In order to achieve the objects mentioned above, the present invention provides a diaphragm, including a diaphragm substrate material having a polymer material layer made of a polymer material and a porous damping material layer made of porous damping material; wherein the polymer material layer is stacked and fixed on the porous damping material layer.

As an improvement, the diaphragm further comprises an adhesive layer arranged between the polymer material layer and the porous damping material layer, wherein the polymer material layer is stacked and glued to one side of the porous damping material layer through the adhesive layer.

As an improvement, the adhesive layer is formed by glue solidification.

As an improvement, the porous damping material layer is made of at least one of polyphthalamide and polyetherketone; and/or, the porous damping material layer is a grid-like structure comprising a plurality of through holes.

As an improvement, the polymer material layer is made of at least one of silicone rubber, thermoplastic elastomer, thermoplastic polyurethane elastomer rubber, polyetheretherketone, and polyethylene terephthalate.

The present invention further provides a method for manufacturing the diaphragm as described above, comprising steps of: providing a polymer material layer and a porous damping material layer respectively, and stacking and bonding the polymer material layer onto the porous damping material layer.

As an improvement, the polymer material layer and the porous damping material layer are stacked and glued together by an adhesive method.

As an improvement, the step of stacking and bonding the polymer material layer and the porous damping material layer is to apply glue on one side surface of the polymer material layer, attach the side surface of polymer material layer coated with glue to porous damping material layer; or, is to apply glue on one side surface of the porous damping material layer, attach the side surface of porous damping material layer coated with glue to polymer material layer; or, is to apply glue on one side surface of the polymer material layer and one side surface of the porous damping material layer, attach the side surface of the polymer material layer coat with glue with the side surface of the porous damping material layer.

The present invention further provides a speaker comprising a magnetic circuit system, a vibration system, a frame provided with an accommodation cavity for receiving the magnetic circuit system and the vibration system, the vibration system comprising a diaphragm as described in claim 1 connected with a top of the frame; wherein the porous damping material layer is arranged on a side of the diaphragm near the frame.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a vibration amplitude change schematic diagram of an existing diaphragm when vibrating respectively 20 ms (millisecond) and 500 ms at different temperatures;

FIG. 2 is an isometric view of a diaphragm substrate material provided in embodiment 1 of the present invention;

FIG. 3 is a front view of the diaphragm substrate material provided in the embodiment 1 of the present invention;

FIG. 4 is an exploded view of the diaphragm substrate material provided in the embodiment 1 of the present invention;

FIG. 5 is a vibration amplitude change schematic diagram of the diaphragm substrate material provided in embodiment 1 of the present invention when vibrating respectively 20 ms and 500 ms at different temperatures;

FIG. 6 is an isometric view of a speaker in accordance with embodiment 1 of the present invention;

FIG. 7 is a cross-sectional view of the speaker taken along line A-A in FIG. 6;

FIG. 8 is a cross-sectional view of a diaphragm substrate material provided in embodiment 2 of the present invention;

FIG. 9 is a vibration amplitude change schematic diagram of the diaphragm substrate material provided in embodiment 2 of the present invention when vibrating respectively 20 ms and 500 ms at different temperatures.

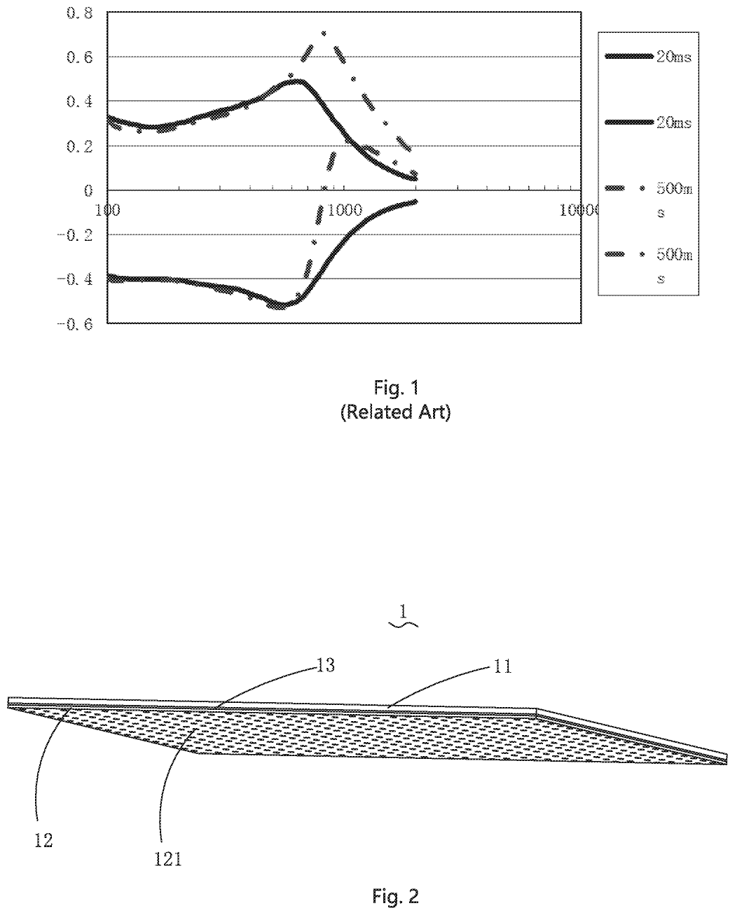

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

### Embodiment 1

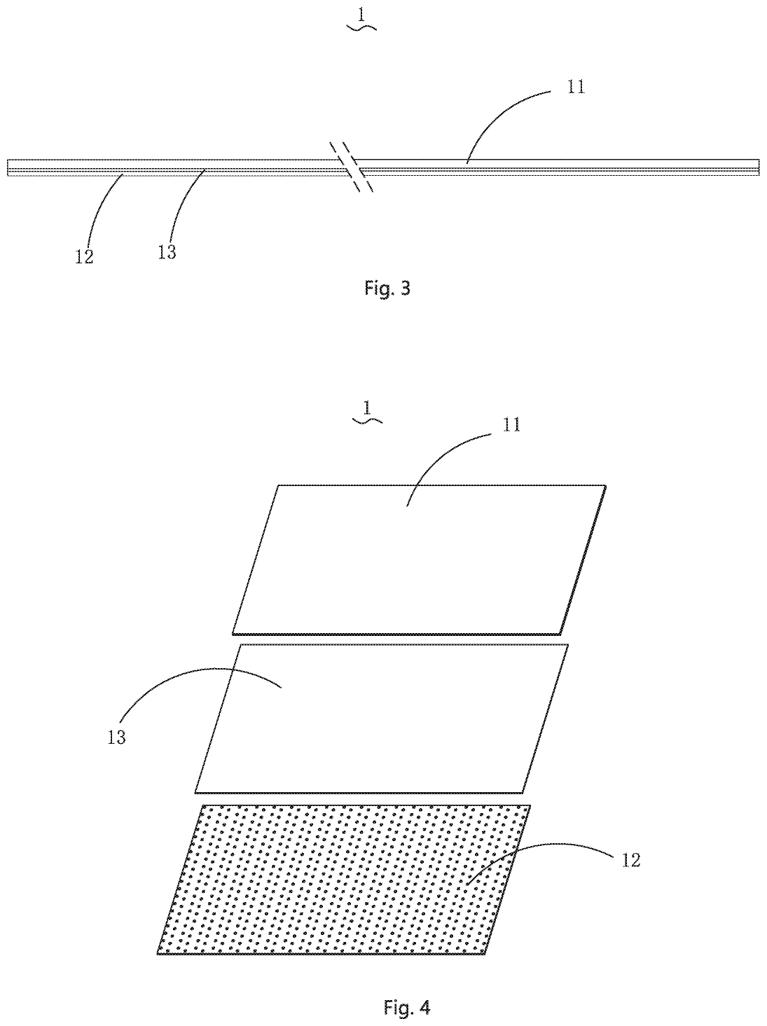

As shown in FIGS. 2-5, a diaphragm substrate material 1 provided in embodiment 1 of the present invention comprises a polymer material layer 11 made of polymer material and a porous damping material layer 12 made of porous damping material. The polymer material layer 11 is stacked and fixed on the porous damping material layer 12. Because porous damping material layer 12 is added to diaphragm substrate material 1 in this embodiment, the porous damping material has high structural strength and can restrain the contractility of polymer materials, so that the dimensions of products made of the diaphragm substrate material 1 of this embodiment can remain consistent. In addition, the diaphragm substrate material 1 of this embodiment can restrain and improve the performance variation of polymer materials under high temperature conditions. Therefore, the vibration amplitudes of products made of the diaphragm substrate material 1 of this embodiment such as speakers have a smaller deviation when temperature increases, so the stability of the product performance improves.

In this embodiment, the diaphragm substrate material 1 further comprises an adhesive layer 13 arranged between a polymer material layer 11 and a porous damping material layer 12, the polymer material layer 11 is stacked and bonded to one side of the porous damping material layer 12 through the adhesive layer 13, the adhesive layer 13 is formed by glue solidification, the porous damping material layer 12 is a grid-like structure comprising many through holes 121.

Preferably, the porous damping material layer is made of at least one of polyphthalamide (PPA) and polyetherketone material (PEK), by which the porous damping materials have high structural strength and can restrain the variation of properties of the polymer material under high temperature conditions.

Preferably, the polymer material layer is made of at least one of silicone rubber, thermoplastic elastomer (TPE), thermoplastic polyurethane elastomer rubber (TPU), polyetheretherketone (PEEK), and polyethylene terephthalate (PET). These high-molecular materials have relatively small elastic modulus and relatively good elasticity.

FIG. 5 is the amplitude change diagram of respective vibration of 20 ms (millisecond) and 500 ms with diaphragm substrate material 1 provided in this embodiment at different temperatures, 20 ms and 500 ms represent different time used to test the diaphragm substrate material 1 of this embodiment in the same frequency phase interval. We can see that the diaphragm substrate material 1 of this embodiment has a small amplitude deviation at the same point on the product under the test conditions of 20 ms and 50 ms.

The present invention, based on the diaphragm substrate material, provides a diaphragm 221. The diaphragm 221 includes the diaphragm substrate material. In fact, when the diaphragm substrate material is used for generating or radiating sounds, the diaphragm substrate material is accordingly serving as a diaphragm.

This embodiment further provides a method for preparing the above-mentioned diaphragm substrate material 1, including the following steps:

Preparing a polymer material layer 11 and a porous damping material layer 12 respectively;

Stacking and fixing the polymer material layer 11 on the porous damping material layer 12 to from diaphragm substrate material 1.

In this embodiment, the polymer material layer 11 and the porous damping material layer 12 are stacked and bonded together by an adhesive method to form diaphragm substrate material 1.

Preferably, polymer material layer 11 and a porous damping material layer 12 are stacked and bonded in any one of the following three ways.

The first way is: applying glue on one side surface of the polymer material layer 11, attaching the side surface of the polymer material layer 11 coated with glue to porous damping material layer 12, then pressing the polymer material layer 11 onto the porous damping material layer 12.

The second way is: applying glue on one side surface of the porous damping material layer 12, attaching the side surface of the porous damping material layer 12 coated with glue to the polymer material layer 11 and then pressing the porous damping material layer 12 onto the polymer material layer 11.

The third way is: applying glue on one side surface of the polymer material layer 11 and on one side surface of the damping material layer 12, attaching the side surface of the polymer material layer 11 coated with glue to the side surface of porous damping material layer 12 coated with glue, then pressing polymer material layer 11 and porous damping material layer 12 to each other tightly.

The diaphragm 221 provided in this embodiment is processed from the aforementioned diaphragm substrate material 1. Because the above-mentioned diaphragm substrate material 1 is used for processing, the vibration amplitude of the diaphragm is smaller when temperature rises, so the product performance is relatively stable. The diaphragm substrate material 1 is processed to form the diaphragm, and specifically the processing operations such as cutting, stamping molding diaphragm substrate material 1 are included.

In fact, the method for manufacturing the diaphragm substrate material is also the method for manufacturing the diaphragm, because the diaphragm is made of the diaphragm substrate material

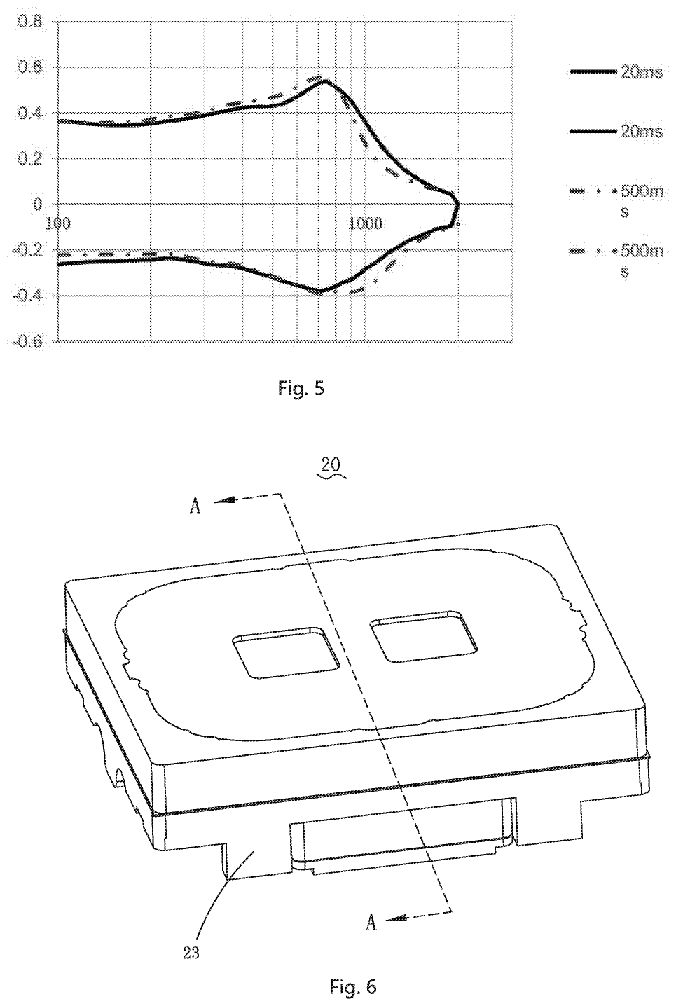

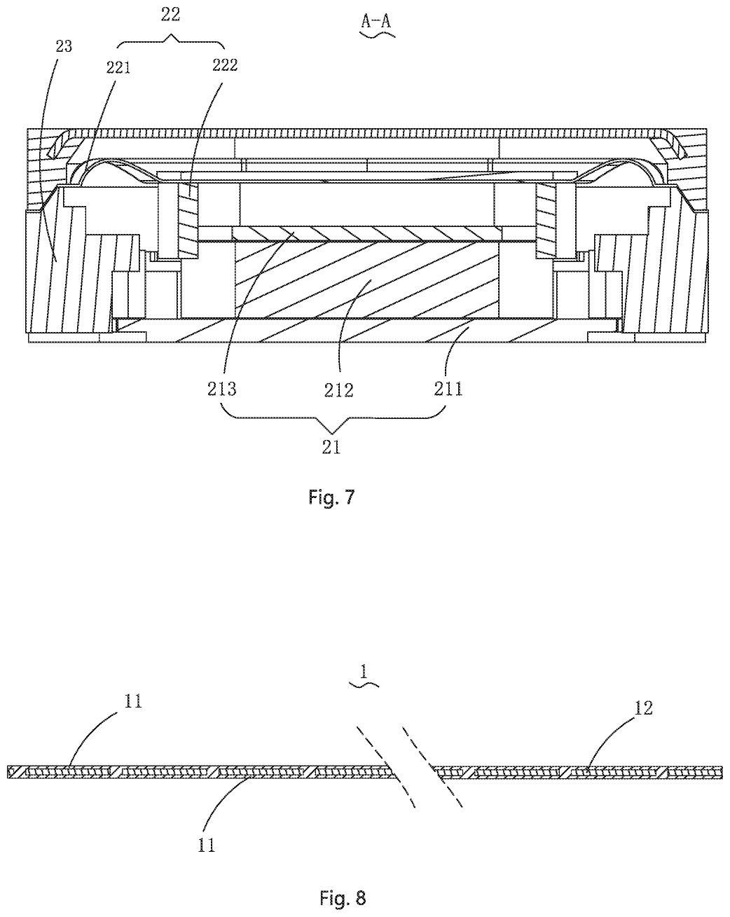

As shown in FIGS. 6-7, a speaker 20 is provided in this embodiment. The speaker 20 comprises a magnetic circuit system 21, a vibration system 22 and a frame 23 provided with an accommodation cavity. Both the magnetic circuit system 21 and the vibration system 22 are accommodated in the accommodation cavity. The vibration system 22 comprises the diaphragm 221 connected to the top of the frame 23. The diaphragm 221 adopts the diaphragm provided in this embodiment, and the porous damping material layer 12 is arranged on a side of the diaphragm 221 near the frame 23. Specifically, the diaphragm 221 comprises a polymer material layer 11 arranged on one side of the diaphragm 221 away from the frame 23, a porous damping material layer 12 arranged on one side of the diaphragm 221 near the frame 23, and an adhesive layer 13 arranged between the polymer material layer 11 and the porous damping material layer 12. In a preferred embodiment, the magnetic circuit system 21 comprises a magnetic frame 211 connected to the bottom of the frame 23, a permanent magnet 212 accommodated in the magnetic frame 211, and a pole core 213 fixed on the top of the permanent magnet 212. The bottom of the permanent magnet 212 is fixed in the magnetic frame 211. The vibration system 22 comprises the diaphragm 221 connected to the top of frame 23, a voice coil 222 arranged at the bottom of the diaphragm 221 and positioned in the accommodation cavity. The voice coil 222 moves under the influence of the magnetic field generated by the magnetic circuit system 21, thereby drives the diaphragm 221 to vibrate up and down.

### Embodiment 2

As shown in FIG. 8, the difference between this embodiment and embodiment 1 is mainly that in the embodiment 1, the polymer material layer 11 and the porous damping material layer 12 are fixed together by an adhesive method; while in this embodiment, the polymer material layer 11 and porous damping material layer 12 are fixed together by high temperature molding. The polymer material layer 11 is embedded in through holes 121 in the porous damping material layer 12.

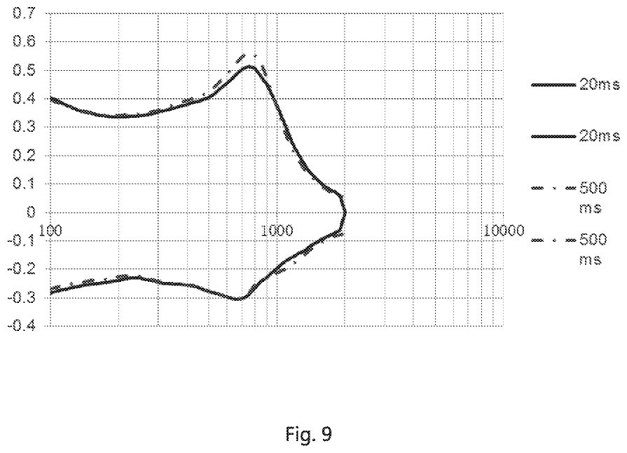

As shown in FIG. 9, it is the amplitude change diagram of respective vibration of 20 ms and 500 ms with diaphragm substrate material 1 provided in this embodiment at different temperatures, 20 ms and 500 ms represent different time used to test the diaphragm substrate material 1 of this embodiment in the same frequency phase interval. From the figure we can see that the diaphragm substrate material 1 of this embodiment has a small amplitude deviation at the same point on the product under the test conditions of 20 ms and 50 ms.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A diaphragm comprising:
a diaphragm substrate material including a polymer material layer made of a polymer material and a porous damping material layer made of porous damping material; wherein
the polymer material layer is stacked and fixed on the porous damping material layer.

2. The diaphragm as described in claim 1 further comprising an adhesive layer arranged between the polymer material layer and the porous damping material layer, wherein the polymer material layer is stacked and glued to one side of the porous damping material layer through the adhesive layer.

3. The diaphragm as described in claim 2, wherein the adhesive layer is formed by glue solidification.

4. The diaphragm as described in claim 1, wherein the porous damping material layer is made of at least one of polyphthalamide and polyetherketone; and/or, the porous damping material layer is a grid-like structure comprising a plurality of through holes.

5. The diaphragm as described in claim 2, wherein the porous damping material layer is made of at least one of polyphthalamide and polyetherketone; and/or, the porous damping material layer is a grid-like structure comprising a plurality of through holes.

6. The diaphragm as described in claim 3, wherein the porous damping material layer is made of at least one of polyphthalamide and polyetherketone; and/or, the porous damping material layer is a grid-like structure comprising a plurality of through holes.

7. The diaphragm as described in claim 4, wherein the polymer material layer is made of at least one of silicone rubber, thermoplastic elastomer, thermoplastic polyurethane elastomer rubber, polyetheretherketone, and polyethylene terephthalate.

8. The diaphragm as described in claim 5, wherein the polymer material layer is made of at least one of silicone rubber, thermoplastic elastomer, thermoplastic polyurethane elastomer rubber, polyetheretherketone, and polyethylene terephthalate.

9. The diaphragm as described in claim 6, wherein the polymer material layer is made of at least one of silicone rubber, thermoplastic elastomer, thermoplastic polyurethane elastomer rubber, polyetheretherketone, and polyethylene terephthalate.

10. A method for manufacturing the diaphragm as described in claim 1, comprising steps of:
providing a polymer material layer and a porous damping material layer respectively;
stacking and bonding the polymer material layer onto the porous damping material layer.

11. The method as described in claim 10, wherein the polymer material layer and the porous damping material layer are stacked and glued together by an adhesive method.

12. The method as described in claim 11, wherein the step of stacking and bonding the polymer material layer and the porous damping material layer is to apply glue on one side surface of the polymer material layer, attach the side surface of polymer material layer coated with glue to porous damping material layer; or,
is to apply glue on one side surface of the porous damping material layer, attach the side surface of porous damping material layer coated with glue to polymer material layer; or,
is to apply glue on one side surface of the polymer material layer and one side surface of the porous damping material layer, attach the side surface of the polymer material layer coat with glue with the side surface of the porous damping material layer.

13. A speaker comprising:
a magnetic circuit system;
a vibration system;
a frame provided with an accommodation cavity for receiving the magnetic circuit system and the vibration system;
the vibration system comprising a diaphragm as described in claim 1 connected with a top of the frame; wherein
the porous damping material layer is arranged on a side of the diaphragm near the frame.
